(19) United States
(12) Patent Application Publication
(10) Pub. No.: US 2026/0239112 A1
(43) Pub. Date: Aug. 13, 2026

(54) METHOD AND APPARATUS FOR RECEIVING AND APPLYING SIGNALS FOR LOWER LAYER CENTRIC MOBILITY PROCEDURE IN A WIRELESS COMMUNICATION SYSTEM

(71) Applicant: Google LLC, Mountain View, CA (US)

(72) Inventors: Yushu ZHANG, Beijing (CN); Jia-Hong LIOU, Taipei City (CN)

(21) Appl. No.: 19/156,249

(22) PCT Filed: Feb. 17, 2023
(86) PCT No.: PCT/CN2023/076952

§ 371 Date: Aug. 13, 2025

(51) Int. Cl. H04W 36/00; H04B 7/06

(52) U.S. Cl. CPC H04W 36/0016; H04B 7/06968; H04W 36/008355

(57) ABSTRACT

Provided user equipment (UEs), network entities and methods, including computer programs encoded on storage media, for receiving and applying signals for a lower layer centric mobility procedure. A UE receives, from a network entity connected to the UE via a source cell, a beam indication for at least one beam usable by the UE to communicate via a target cell among one or more candidate cells with the network entity. The UE receives, from the network entity, a cell switch command CSC indicating the target cell. The beam indication is effective at a first time and the CSC is effective at a second time. The UE switches from the source cell to the target cell and using the at least one beam. The UE resolves a timing conflict generated by a difference between the first time and the second time, based on a predetermined rule.

### TECHNICAL FIELD

The present disclosure relates generally to wireless communication, and more particularly, to performing a lower layer centric mobility procedure.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies that support communication with multiple UEs. Improvements in mobile broadband continue the progression of such wireless communication technologies. For example, a lower layer centric mobility procedure (LLCMP) may present some timing issues related to receiving and applying signals related to the LLCMP. The signals related to the LLCMP are a beam indication specifying beams usable by the target cell and a cell switch command (CSC) specifying the target cell.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A lower layer centric mobility procedure (LLCMP) (which, for example, may be a L1/L2 triggered mobility procedure) can reduce latency compared with higher layer mobility procedures when switching from using a source cell to using a target cell for communications between a user equipment (UE) and a network entity by avoiding an exchange of higher layer messages and UE reconfiguration. However, the LLCMP may present some timing issues, for example, timing conflicts, related to receiving and applying signals related to the LLCMP. The signals related to the LLCMP are a beam indication specifying beams usable by the target cell and a cell switch command (CSC) specifying the target.

First, the UE may have timing issues in handling the CSC and the beam indication for the same procedure. The beam indication may specify beams using transmission configuration indicator, TCI states. The beams specified via the beam indication may be related to any cell including but not limited to the target cell among from one or more candidate cells. The CSC is the LLCMP signal that indicates the target cell. Different time delays between the receiving and the applying of the CSC and the beam indication, respectively, may result in different action times of CSC and beam indication even if the UE receives both at the same time or slot. Action time refers to when the UE applies the CSC (or the beam indication) and is determined by a predetermined delay after the UE receives the CSC (or the beam indication). Second, the predetermined delays can be non-identical for the source cell and the target cell. Third, the UE may have difficulty in determining when to release or discard beams indicated in a beam indication not associated with a CSC Fourth, the UE may have difficulty in determining when to start or restart a timer used in monitoring completion of the LLCMP. Aspects of the present disclosure address the above-noted and other deficiencies by providing mechanisms for the UE to resolve the timing issues associated with the CSC and the beam indication when the UE performs the LLCMP. The present disclosure also provides mechanisms for the UE to adjust the action time of the beam indication or the CSC. The present disclosure also provides mechanisms for the UE when receiving one beam indication or CSC and when to start or restart a timer used in monitoring completion of the LLCMP.

According to some aspects, the UE receives, from a network entity connected to the UE via a source cell, a beam indication and a CSC. The beam indication specifies one or more beams usable by a target cell among one or more candidate cells. The CSC, indicates the target cell. The beam indication is effective at a first time and the CSC is effective at a second time. The UE then switches from the source cell to the target cell and uses a beam specified in the beam indication. A timing conflict generated by a difference between the first time and the second time is resolved based on a predetermined rule. For example, the predetermined rule may require using a flexible action time instead of one of the first time and the second time, extends the shorter among the first and second time to match the longer thereof, and/or requires using a default beam to initiate the switching until the first time, if the first time is later than the second time.

According to some aspects, a network entity directs a user equipment (UE) via a source cell, to use a predetermined rule for resolving a timing conflict associated with a beam indication and a cell switch command (CSC) that define a procedure for the UE to switch from the source cell to a target cell specified in the CSC and to use a beam specified in the beam indication for communicating in the target cell. The network entity receives from the UE a signal indicating the UE initiating the procedure.

### BRIEF DESCRIPTION OF THE DRAWINGS

FIG. 1 illustrates a diagram of a wireless communications system that includes a plurality of user equipments (UEs) and network entities in communication over one or more cells.

FIGS. 2A-2C illustrates diagrams of a time delay difference between the CSC and the beam indication and action times of the cell switch command (CSC) and the beam indication.

FIG. 3 illustrates a signaling diagram of an example scenario in which UE and network entity exchanges messages and implement procedures for performing a lower layer centric mobility procedure, according to some embodiments.

FIG. 4 illustrates a signaling diagram of an example scenario in which UE and network entity exchanges messages and implement procedures for performing a lower layer centric mobility procedure, according to some embodiments.

FIG. 5 illustrates a signaling diagram of an example scenario in which UE and network entity exchanges messages and implement procedures for performing a lower layer centric mobility procedure, according to some embodiments.

FIG. 6 is a flow diagram illustrating an example method of a lower layer centric mobility procedure, according to some embodiments.

FIG. 7 is a flow diagram illustrating an example method of a lower layer centric mobility procedure, according to some embodiments.

FIG. 8 is a flow diagram illustrating an example method of a lower layer centric mobility procedure, according to some embodiments.

FIG. 9 is a flow diagram illustrating an example method of a lower layer centric mobility procedure, according to some embodiments.

FIG. 10 is a flowchart of a method of wireless communication at a UE.

FIG. 11 is a flowchart of a method of wireless communication at a network entity.

FIG. 12 is a diagram illustrating a hardware implementation for an example UE apparatus.

FIG. 13 is a diagram illustrating a hardware implementation for one or more example network entities.

### DETAILED DESCRIPTION

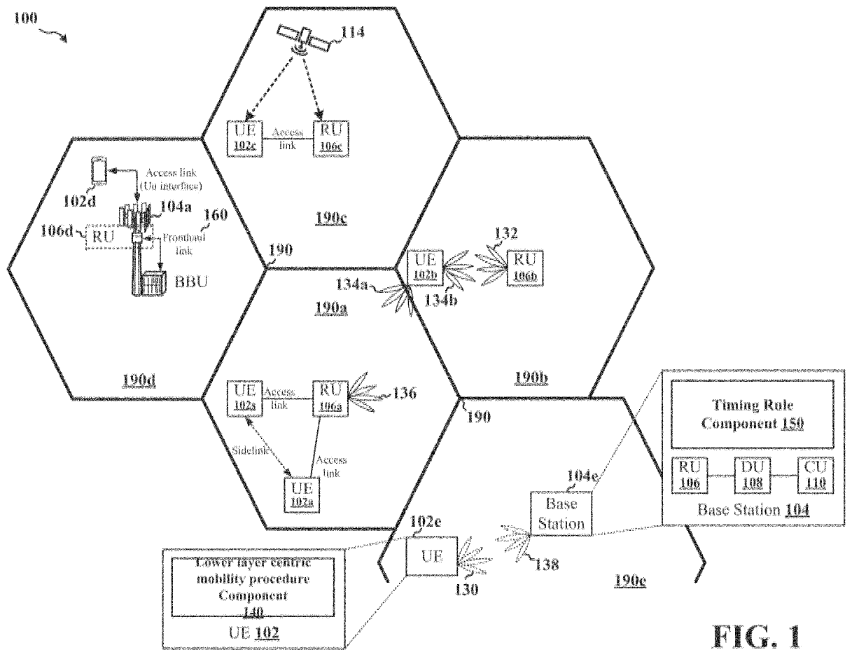

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106, the DU 108, or the CU 110), may be referred to as a transmission reception point (TRP).

Operations of the base station 104 and/or network designs may be based on aggregation characteristics of base station functionality. For 1 example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104a/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102B of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Both real-time and non-real-time features of control plane and user plane communications of the RUs 106 can be controlled by associated DUs 108.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 might relay communications between the UEs 102 and the core network. The base stations 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas 114 of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHZ (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1 ) and frequency range 2 (FR2). FR1 ranges from 410 MHz-7.125 GHz and FR2 ranges from 24.25 GHz-71.0 GHz, which includes FR2-1 (24.25 GHz-52.6 GHZ) and FR2-2 (52.6 GHz-71.0 GHZ). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHZ-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 might or might not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU 112 that includes a DU 108 and a CU 110, or as a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include a lower layer centric mobility procedure component 140 configured to receive, from a network entity connected to the UE via a source cell, a beam indication for at least one beam usable by the UE to communicate via a target cell among one or more candidate cells with the network entity; to receive, from the network entity, a cell switch command, CSC, indicating the target cell, wherein the beam indication is effective at a first time and the CSC is effective at a second time; and to switch from the source cell to the target cell and using the at least one beam, wherein a timing conflict generated by a difference between the first time and the second time is resolved based on a predetermined rule.

In certain aspects, any of the base stations 104 or a network entity of the base stations 104 may include a timing rule component 150 configured to direct a user equipment, UE, via a source cell, to use a predetermined rule for resolving a timing conflict associated with a beam indication and a cell switch command, CSC that define a procedure for the UE to switch from the source cell to a target cell specified in the CSC and to use a beam indicated in the beam indication for communicating in the target cell; and to receive from the UE a signal indicating the UE initiating the procedure.

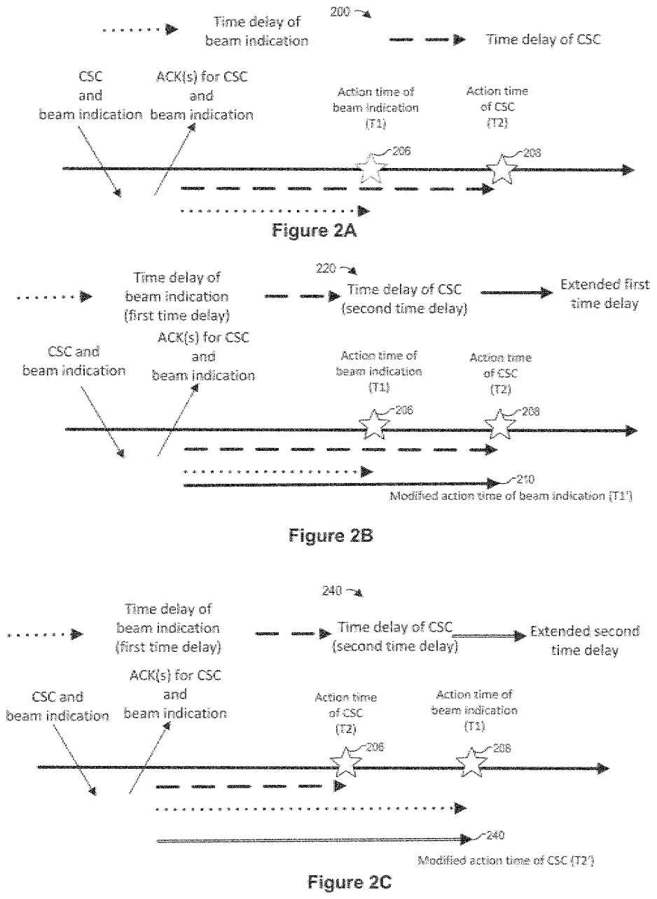

Accordingly, FIG. 1 describes a wireless communication system that may be implemented in connection with aspects of one or more other figures described herein, such as aspects illustrated in FIGS. 2-13. Further, although the following description may be focused on 5G NR, the concepts described herein may be applicable to other similar areas, such as 5G-Advanced and future versions, LTE, LTE-advanced (LTE-A), and other wireless technologies, such as 6G.

FIG. 2A illustrates a diagram 200 of a time delay difference between the CSC and the beam indication and action times of the CSC and the beam indication. A different time delay may result in a different action time for the CSC and the beam indication although the UE 102 receives the CSC and the beam indication at the same time or within the same slot. Note that the action time may mean the timing when the cell switch command (or beam indication) is applied or effective after the UE 102 receives the cell switch command (or beam indication). The time delay may be different for the source cell and the target cell although the signaling of the beam indication is received via a DCI or a MAC-CE.

FIGS. 2B-2C illustrate diagrams 220, 240 of how the first delay or the second delay can be extended. If the UE 102 receives the beam indication of a candidate cell and the CSC indicating the candidate cell (could be at the same time or different time), and if the first delay, T1 206 is different from the second delay, T2 208, one of the first delay, T1 206 or the second delay, T2 208 can be extended. For example, T1 can be extended such that T1′ 210 (an extended value of the first delay, T1 206) is equal to T2 206. Similarly, the second delay, T2 208 can be extended such that T2′ (an extended value of the second delay) is equal to T1.

Referring to FIG. 2B, for example, if T1 206 is earlier than T2 208, T1 206 is extended such that an action time of beam indication for the candidate cell T1′ 210 is equal to T2.

Referring to FIG. 2C, if T2 208 is earlier than T1 206, T2 208 is extended such that an action time of the CSC indicating the candidate cell T2′ 240 is equal to T1.

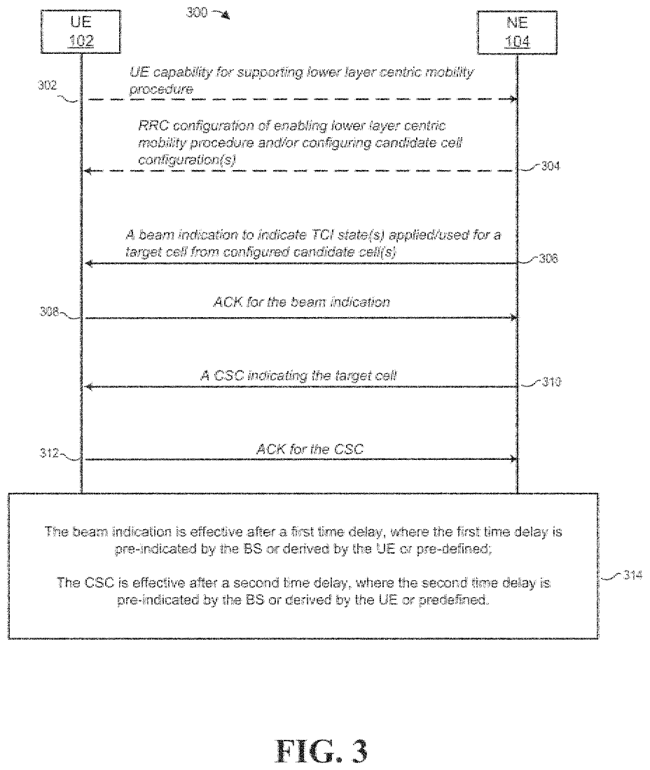

FIGS. 2A-2C illustrate examples of the time delay difference between the CSC and the beam indication and action times of the CSC and the beam indication. Thus, FIG. 3 illustrates a signaling diagram of an example scenario in which user equipment (UE) and network entity exchanges messages and implement procedures for a lower layer centric mobility procedure to address these technical concerns.

FIG. 3 illustrates a signaling diagram 300 of an example scenario in which UE and network entity exchanges messages and implement procedures for performing a lower layer centric mobility procedure, according to some embodiments. The network entity 104 may correspond to the base station or an entity at the base station, such as the RU 106, the DU 108, the CU 110, etc.

In some examples, initially, the UE 102 may transmit 302, to the network entity 104, a UE capability report for supporting UE capability for supporting lower layer centric mobility procedure. As an alternative to over-the-air UE capability reporting, the network entity 104 may receive the one or more UE capabilities from a core network entity, such as an AMF. Based on the one or more UE capabilities, the network entity 104 transmits 304, to the UE 102, a RRC configuration that enables a function of lower layer centric mobility procedure and/or configure candidate cell configurations. The network entity 104 transmits 306, to the UE 102, a beam indication to indicate TCI state(s) applied/used for a target cell from configured candidate cell(s). In response, the UE 102 may transmit 308, to the network entity 104, an acknowledgment for the beam indication. Moreover, the network entity 104 further transmits 310, to the UE 102, a CSC indicating the target cell. In response, the UE 102 may transmit 312, to the network entity 104, an acknowledgement for the CSC.

In block 314, the beam indication is effective after a first time delay. The CSC is effective after a second time delay. The network entity 104 or the UE 102 may indicate the first time delay or the second time delay.

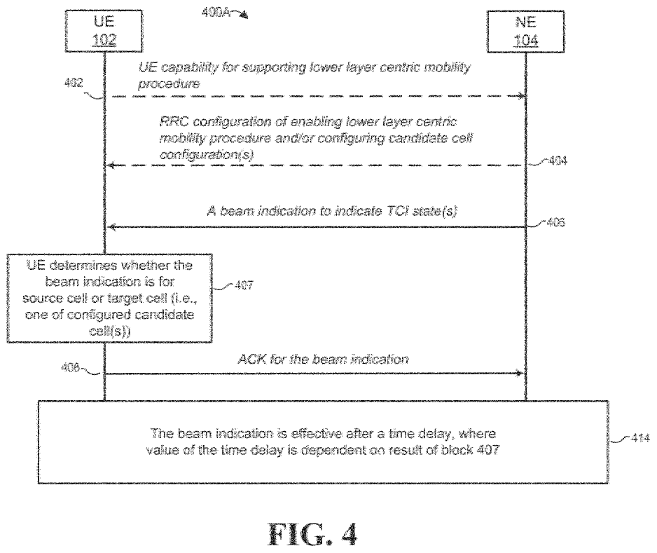

FIG. 3 describes a signaling diagram of an example scenario in which a user equipment (UE) and a network entity exchange messages and implement procedures for performing a lower layer centric mobility procedure, and FIG. 4 describes a signaling diagram of another example scenario in which a user equipment (UE) and a network entity exchange messages and implement procedures for performing a lower layer centric mobility procedure.

FIG. 4 illustrates a signaling diagram 400 of another example scenario in which a user equipment (UE) and a network entity exchange messages and implement procedures for performing a lower layer centric mobility procedure.

At the beginning of the example scenario 400, the UE 102 may transmit 402, to the network entity 104, a UE capability report for supporting UE capability for supporting lower layer centric mobility procedure. Similar to 304, the network entity 104 transmits 404, to the UE 102, a RRC configuration that enables a function of lower layer centric mobility procedure and/or configure candidate cell configurations. Similar to 306, the network entity 104 transmits 406, to the UE 102, a beam indication to indicate TCI states. Then, the UE 102 determines 407 whether the beam indication is intended for the source cell or the target cell (i.e., one of configured candidate cell(s)). The UE 102 may transmit 408, to the network entity 104, an acknowledgement for the beam indication. In block 414, the beam indication is effective after a time delay, where value of the time delay depends on whether the beam indication is intended for the source cell or the target cell.

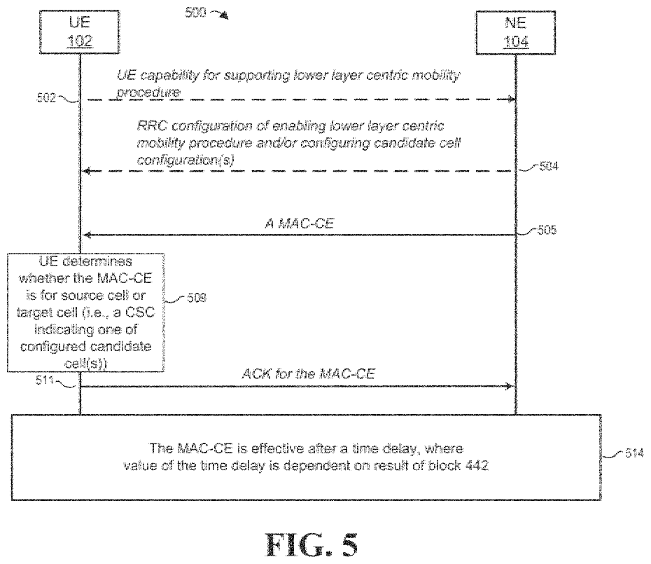

FIG. 4 illustrates a signaling diagram 400 of another example scenario in which a user equipment (UE) and a network entity exchange messages and implement procedures for performing a lower layer centric mobility procedure. FIG. 5 illustrates a signaling diagram 500 of another example scenario in which a user equipment (UE) and a network entity exchange messages and implement procedures for performing a lower layer centric mobility procedure.

Similar to the signaling diagram 400, the UE 102 in FIG. 5 may transmit 502, to the network entity 104, a UE capability report for supporting UE capability for supporting the lower layer centric mobility procedure. Similar to 304 and 404, the network entity 104 in the signaling diagram 500 transmits 504, to the UE 102, a RRC configuration that enables a function of lower layer centric mobility procedure and/or configure candidate cell configurations. The network entity 104 transmits 505, to the UE 102, a MAC-CE. Then, the UE 102 determines 507 whether the MAC-CE is for the source cell or the target cell (i.e., a CSC indicating one of configured candidate cell(s)). The UE 102 may transmit 508 an acknowledgement for the CSC. In block 514, it is indicated that the MAC-CE is effective after a time delay, where value of the time delay on whether the MAC-CE is intended for the source cell or the target cell.

In some implementations, a TRP can be associated with or identified by a TRP identifier. In some implementations, a base station (e.g., the network entity 104 or 106) includes or configures a TRP identifier in uplink (UL) configurations that the network entity 104 transmits to a UE (e.g., the UE 102) for UL transmissions via a TRP identified by the TRP identifier. In some implementation, the UL configurations include downlink control information (DCI) transmitted on a PDCCH, and/or physical uplink shared channel (PUSCH) configuration, physical uplink control channel (PUCCH) configuration and/or sounding reference signal (SRS) configuration included in a RRC message (e.g., RRC reconfiguration message or a RRC resume message) that network entity 104 transmits to the UE 102. In some implementations, the UL transmissions include PUSCH transmissions, PUCCH transmissions and/or SRS transmissions. In some implementations, the network entity 104 includes a TRP identifier in downlink (DL) configurations that the network entity 104 transmits to the UE 102 for DL transmissions via a TRP identified by the TRP identifier. In one implementation, the DL configurations include DCI transmitted on a PDCCH, and/or channel state information (CSI) resource configuration, physical downlink shared channel (PDSCH) configurations and/or physical downlink control channel (PDCCH) configurations included in a RRC message (e.g., RRC reconfiguration message or a RRC resume message) that the network entity 104 transmits to the UE 102. In some implementations, the DL transmissions include CSI reference signal (CSI-RS) transmissions, synchronization signal block (SSB) transmissions, PDSCH transmissions and/or PDCCH transmissions.

In other implementations, the network entity 104 does not transmit or configure a TRP identifier to the UE 102 and the network entity 104 uses an implicit indication to indicate a TRP to the UE 102. In one implementation, the implicit indication can be one of the following configuration parameters: a CORESETPoolIndex, a (candidate) value of a CORESETPoolIndex, dataScramblingIdentityPDSCH, dataScramblingIdentityPDSCH2-r16, or PUCCH-ResourceGroup-r16. In such implementations, the UE 102 derives a TRP (identifier) from the implicit indication. In some implementations, the network entity 104 transmits a RRC message (e.g., RRC reconfiguration message or a RRC resume message) including the configuration parameters to the UE 102.

In some implementations, the network entity 104 configures or indicates the UE a first TRP identifier. In some implementations, the UE 102 derives a first TRP identifier (value). In some implementations, the network entity 104 configures or indicates the UE 102 a second TRP identifier (value). In some implementations, the UE 102 derives a second TRP identifier (value). In some implementations, the first TRP identifier can be associated with the first TRP. In some implementations, the second TRP identifier can be associated with the second TRP.

In some implementations, the network entity 104 configures that a serving cell is associated with the first TRP or the first TRP identifier (value). In some implementations, the network entity 104 configures a first control resource set (CORESET) associated with the serving cell or first TRP. The network entity 104 can configure CORESETPoolIndex #0 to identify the first CORESET. In one implementation, the network entity 104 can transmit to the UE a RRC message (e.g., a RRC setup message, a RRC reconfiguration message or a RRC resume message) configuring the first CORESET and/or including the CORESETPoolIndex #0. Thus, the UE 102 monitors a PDCCH on the first CORESET to receive DCIs from the network entity 104, which implies that the UE 102 monitors a PDCCH or receives DCIs via the first TRP from the network entity 104 (i.e., from the first TRP). In such a case, the UE 102 determines that CORESETPoolIndex #0 indicates a TRP (i.e., the first TRP) of the network entity 104.

In one implementation, the network entity 104 configures that the serving cell associated with the second TRP or the second TRP identifier (value). In other implementation, the second TAG is associated with a non-serving cell, and the network entity 104 indicates or configures the association in the second RRC message. In one implementation, the network entity 104 configures the non-serving cell associated with the second TRP or the second TRP identifier (value). In some implementations, the network entity 104 configures a second CORESET is associated with the serving cell, non-serving cell or second TRP. The network entity 104 can configure CORESETPoolIndex #1 to identify the second CORESET. In one implementation, the network entity 104 can transmit to the UE a RRC message (e.g., a RRC setup message, a RRC reconfiguration message or a RRC resume message) configuring the second CORESET and/or including the CORESETPoolIndex #1. Thus, the UE 102 monitors a PDCCH on the second CORESET to receive DCIs from the network entity 104, which implies that the UE 102 monitors a PDCCH or receives DCIs via the second TRP from the network entity 104 (i.e., from the second TRP). In such a case, the UE 102 determines that CORESETPoolIndex #1 indicates a TRP (i.e., the second TRP).

In some implementations, the network entity 104 can configure the UE 102 one or more TCI state lists for a component carrier (CC) of a serving cell, where the CC might be PCell or SCell. For example, the network entity 104 can configure a joint TCI state list for a CC of a serving cell. For example, the network entity 104 can configure a DL TCI state list and/or a UL TCI state list for a CC of a serving cell. One joint TCI state list can include one or more joint TCI states. One DL TCI state list can include one or more DL TCI states. One UL TCI state list can include one or more UL TCI states.

In some implementations, the network entity 104 can configure the UE a RRC parameter unifiedTCI-StateType. The RRC parameter unifiedTCI-StateType can be a per-serving-cell configuration. The RRC parameter unifiedTCI-StateType can indicate which type of TCI state list(s) for a serving cell. For example, the RRC parameter unifiedTCI-StateType can indicate “joint” or “separate”. The RRC parameter unifiedTCI-StateType can provide one or more the following purpose: if the first RRC parameter for a CC of serving cell indicates “joint”, the network entity 104 might explicitly or implicitly configure the UE one or more joint TCI state list(s) for the CC of serving cell or the UE 102; if the first RRC parameter for a CC of serving cell indicates “separate”, the network entity 104 might explicitly or implicitly configure the UE one or more DL TCI state list(s) for the CC of serving cell; if the first RRC parameter for a CC of serving cell indicates “separate”, the network entity 104 might explicitly or implicitly configure the UE one or more UL TCI state list(s) for the CC of serving cell.

In some implementations, if the network entity 104 explicitly configures the UE one or more TCI state list(s) for a CC of a serving cell, it might imply that the network entity 104 configures the one or more TCI state list(s) (explicitly) under RRC configuration (e.g., ServingCellConfig) for a CC of the serving cell.

In some implementations, if the network entity 104 implicitly configures the UE one or more TCI state list(s) for a CC of serving cell, it might imply at least one of the followings: the network entity 104 configures the one or more TCI state list(s) under RRC configuration (e.g., ServingCellConfig) for other serving cell(s)/CCs or a reference serving cell/CC; the UE refers the one or more TCI state list(s) for other serving cell(s)/CCs or a reference serving cell/CC; the UE 102 determines that the one or more TCI state list(s), which is for other serving cell/CCs or a reference serving cell/CC, is also for the CC of the serving cell.

In some implementations, the network entity 104 can transmit a first MAC-CE to the UE 102 when or after the network entity 104 configures the UE 102 one or more TCI state list(s) for the CC of serving cell; and/or the UE 102 refers or determines one or more TCI state list(s) for the CC of serving cell.

In some implementations, the first MAC-CE can activate or indicate one or more TCI states from the one or more TCI state list(s). The one or more TCI states activated/indicated by the first MAC-CE can map to one or more TCI codepoints in a TCI field. In some cases, the UE 102 can (directly) apply or use the one or more TCI states activated/indicated by the first MAC-CE for performing DL and/or UL transmission (subsequently).

In some implementations, if the number of TCI states activated/indicated by the first MAC-CE is larger than one, those TCI states activated/indicated by the first MAC-CE can map to one or more TCI codepoints in a TCI field in a DCI. In some implementations, if the number of TCI states activated/indicated by the first MAC-CE is one, the UE 102 can (directly) apply or use the TCI state activated/indicated by the first MAC-CE for performing DL and/or UL transmission (subsequently). In some implementations, if the number of TCI states activated/indicated by the first MAC-CE is two, and/or if the two TCI states activated/indicated by the first MAC-CE are associated with different TRP identifier or applicable for different TRP, the UE 102 can (directly) apply or use these two TCI states activated/indicated by the first MAC-CE for performing corresponding DL and/or UL transmission (subsequently).

In some implementations, one TCI state can be mapped to one TCI codepoint, based on the first MAC-CE. In some cases, more than one TCI states can be mapped to one TCI codepoint, based on the first MAC-CE. In some cases, the TCI codepoint can indicate one of the followings: one or more joint TCI states, some might be TCI states associated with the first TRP, the other might be TCI states associated with the second TRP one or more DL TCI states, some might be TCI states associated with the first TRP, the other might be TCI states associated with the second TRP one or more UL TCI states, some might be TCI states associated with the first TRP, the other might be TCI states associated with the second TRP one or more DL TCI states and one or more UL TCI states, some might be TCI states associated with the first TRP, the other might be TCI states associated with the second TRP.

In some cases, the number of joint TCI states indicated in a TCI codepoint by the network entity 104 can be up to 4. In some cases, the number of DL TCI states indicated in a TCI codepoint by the network entity 104 can be up to 4. In some cases, the number of UL TCI states indicated in a TCI codepoint by the network entity 104 can be up to 4.

For example, one of the followings can be mapped to a TCI codepoint: one joint TCI state associated with the first TRP, one joint TCI state associated with the second TRP, one DL TCI state associated with the first TRP, one UL TCI state associated with the second TRP, one DL TCI state associated with the first TRP, one DL TCI state associated with the second TRP, one UL TCI state associated with the first TRP, one UL TCI state associated with the second TRP, one DL TCI state and one UL TCI state associated with the first TRP, one joint TCI state associated with the second TRP, one DL TCI state and one UL TCI state associated with the first TRP, one DL TCI state associated with the second TRP, one DL TCI state and one UL TCI state associated with the first TRP, one ULTCI state associated with the second TRP.

In some implementations, the UE 102 can receive a first DCI indicating one or more TCI states. The first DCI can indicate one or more TCI states by the TCI field in the first DCI. In response to receiving the first DCI, the UE can transmit, to the network entity 104, a first acknowledgement signal via a PUCCH or PUSCH transmission. In response to transmitting the first acknowledgement signal, the UE 102 can apply or use the one or more TCI states activated or indicated by the first DCI for performing DL and/or UL transmission. In some cases, in response to transmitting the first acknowledgement signal, the UE 102 can apply or use the one or more TCI states activated/indicated by the first DCI for performing DL and/or UL transmission, after a first application time period. In some cases, the UE can apply or use the one or more TCI states activated/indicated by the first DCI for performing DL and/or UL transmission, starting from a first slot.

In some cases, the first slot can be the earliest slot that is at least the first application time period after the last symbol of the PUCCH or PUSCH transmission. In some cases, the earliest slot (for determining the first slot) and/or the first application time period can be determined based on the active BWP with the smallest SCS among the active BWP(s) of the carrier/serving cell(s) applying the one or more TCI states. In some cases, the first application time period can be in unit of one of the followings: symbol, sub-slot, slot, sub-frame, frame, millisecond, or second. In some cases, the first application time period can be beamAppTime.

In other implementations, the UE 102 can receive the first MAC-CE indicating one or more TCI states. For example, the first MAC-CE might indicate one TCI state. For example, the first MAC-CE might indicate more than one TCI states, each of them can be associated with different TRP or TRP identifier. For example, the first MAC-CE might indicate two TCI states, where one is associated with the first TRP (identifier) and the other is associated with the second TRP (identifier). In such cases, the UE 102 might not receive a DCI indicating one or more TCI states for applying for subsequent DL and/or UL transmission. In response to receiving the first MAC-CE, the UE can transmit, to the network entity 104, a second acknowledgement signal via a PUCCH or PUSCH transmission. In response to transmitting the second acknowledgement signal, the UE can apply or use the one or more TCI states activated/indicated by the first MAC-CE for performing DL and/or UL transmission. In some cases, in response to transmitting the second acknowledgement signal, the UE 102 can apply or use the one or more TCI states activated/indicated by the first MAC-CE for performing DL and/or UL transmission, after a second application time period. In some cases, the UE 102 can apply or use the one or more TCI states activated/indicated by the first MAC-CE for performing DL and/or UL transmission, starting from a second slot.

In some cases, the second slot can be the earliest slot that is at least the second application time period after the (last) slot of the PUCCH or PUSCH transmission. In some cases, the second application time period can be

$$3 {N}_{slot}^{Subframe , μ} + \frac{{2}^{μ}}{{2}^{{μ}_{{K}_{mac}}}} \cdot {k}_{mac} .$$

In some cases, μ can be the SCS configuration for the PUCCH or PUSCH transmission; μ_{K}_{_{mac}} can be the subcarrier spacing configuration for k_{mac} with a value of 0 for frequency range 1, and k_{mac} is provided by K-Mac or k_{mac}=0 if K-Mac is not provided.

In some cases, the network entity 104 can configure the UE 102 a RRC parameter unifiedTCI-StateRef. The RRC parameter unifiedTCI-StateRef can be a per-cell or per-BWP configuration. In some cases, if the network entity 104 configures, to the UE, the RRC parameter unifiedTCI-StateRef for a CC of serving cell and/or a BWP, it might imply one of the followings: the network entity 104 does not configure one or more TCI state list(s) under RRC configuration (e.g., ServingCellConfig) for the CC of serving cell and/or RRC configuration for the BWP; the UE refers one or more TCI state list(s) for the serving cell and/or the BWP from a reference serving cell/CC and/or a reference BWP; the UE determines that the one or more TCI state list(s), which is for the reference serving cell/CC and/or the reference BWP, is also for the CC of serving cell and the BWP. In some cases, the RRC parameter unifiedTCI-StateRef can at least indicate a cell index of the reference serving cell. In some cases, the RRC parameter unifiedTCI-StateRef can at least indicate a BWP ID of the reference BWP.

In some implementations, the network entity 104 might configure the UE 102 one or more candidate cell configuration(s). The one or more candidate cell configuration(s) might include information of neighboring cell(s) of the UE 102. The one or more candidate cell configuration(s) might include information of candidate target cell of the UE 102 for performing a lower layer centric mobility procedure. A candidate cell configuration might include or be one of a RRCReconfiguration message, a CellGroupConfig IE or a SpCellConfig IE. A candidate cell configuration might include a candidate cell configuration ID. A candidate cell might be current configured/activated secondary cell (SCell) of the UE. In some cases, a candidate cell might be a configured/activated secondary cell (SCell) of the UE 102 before the UE 102 receives a CSC or starts/performs a LLCMP.

In some implementations, the candidate cell configuration may include one or more TCI state(s) or TCI state lists for a candidate cell. In some implementations, the network entity 104 might transmit to the UE 102 a cell switch command. In one example, the network entity 104 might transmit the cell switch command via MAC-CE or PDSCH. In some implementations, the UE 102 might receive a second DCI from the network entity 104. The second DCI might schedule a PDSCH carrying the CSC.

In some implementations, the CSC might indicate a target cell. In some implementations, the CSC might include a candidate cell configuration ID. It is noted that throughout this disclosure, a target cell might be or stand for a candidate cell indicated by the CSC. In response to receiving the CSC or after the action time of the CSC, the UE 102 might perform lower layer centric mobility procedure based on the CSC. The UE 102 might determine the target cell and/or its corresponding configuration based on the candidate cell configuration ID indicated in the cell switch command. Upon completing the lower layer centric mobility procedure, the target cell indicated by the cell switch command might become a new serving cell or a PCell. Upon completing the lower layer centric mobility procedure, the UE 102 moves from the source cell to the target cell. It is noted that throughout this disclosure, the source cell might be the (original or previous) serving cell before receiving the CSC or completing lower layer centric procedure.

In some implementations, the network entity 104 might configure the UE 102 one or more TCI states for one or more candidate cell(s). In some implementations, the network entity 104 might configure the UE 102 one or more TCI states for a candidate cell indicated by the CSC (i.e., target cell). In some implementations, the network entity 104 might transmit a MAC-CE to activate one or more TCI state(s) from the one or more configured TCI states for the target cell.

In some implementations, the UE 102 might receive a beam indication for indicating that which one TCI state or activated TCI state is used or applied for the target cell. The beam indication might indicate that which one TCI state or activated TCI state is the indicated TCI state for the target cell. If the network entity 104 activates more than one TCI state, the beam indication might be a DCI (e.g., the second DCI or other DCIs not scheduling the CSC) or another MAC-CE. If the network entity 104 activates only one TCI state, the beam indication might be the MAC-CE used by the network entity 104 to activate the only one TCI state. This might imply that the only one activated TCI state is the indicated TCI state or directly used or applied for the target cell.

In some implementations, an action time of beam indication for the target cell (e.g., T1) might be a timing (e.g., a slot or symbol) after a first time delay. In some other implementations, an action time of the CSC (e.g., T2) might be a timing (e.g., a slot or symbol) after a second time delay. The first and/or the second time delay may start or apply after one of the following: after X1 symbol(s) (or slot(s) or millisecond) after the UE 102 receives the first or last symbol of PDCCH or PDSCH with the beam indication for the target cell or the CSC, where X1 is predefined. For example, X1 might be 0, or reported by the UE via UE capability report, or configured by the network entity 104 via higher layer signaling, e.g., RRC signaling, or indicated by the network entity 104 via a MAC-CE or DCI; after X2 symbol(s) (or slot(s) or millisecond) after the UE transmits the first or last symbol of the PUSCH or PUCCH with ACK for the beam indication for the target cell or the CSC, where X2 is predefined. For example, X2 might be 0, or reported by the UE via UE capability report, or configured by the network entity 104 via higher layer signaling, e.g., RRC signaling, or indicated by the network entity 104 via a MAC-CE or DCI.

In some implementations, the first time delay might be different from the second time delay. In some implementations, action time of beam indication for the target cell might different from action time of the CSC scheduled by the second DCI even that the first time delay and the second time delay are started or applied at the same time or slot or symbol. In some implementations, action time of beam indication for the target cell might be different from action time of the CSC scheduled by the second DCI even that the UE receives (or transmits ACK for) the beam indication and the CSC at the same time or slot or symbol.

In some implementations, the network entity 104 may indicate the first time delay and/or the second time delay by using a DCI or a MAC-CE or a RRC message. If the network entity 104 indicates the first time delay and/or the second time delay using a DCI, the indication may be included in the first DCI or the second DCI. If the network entity 104 indicates the first time delay and/or the second time delay by using a MAC-CE, the indication may be included in the CSC or another one MAC-CE. If the network entity 104 indicates the first time delay and/or the second time delay by using an RRC message, the indication may be included in the serving cell configuration or candidate cell configuration(s).

Referring to FIGS. 2B-2C, in some implementations, if the UE 102 receives a beam indication of a candidate cell and a CSC indicating the candidate cell (could be at the same time or different time), and if T1 is different from T2, one of the first delay or the second delay can be extended such that T1′ (with extended value of the first delay) is equal to T2 or T1 is equal to T2′ (with extended value of the second delay).

Referring to FIG. 2B, in some implementations, if the UE 102 receives a beam indication of a candidate cell and a CSC indicating the candidate cell (could be at the same time or different time), and if T1 is earlier than T2, the first delay can be extended such that action time of beam indication for the candidate cell becomes T1′, where T1′ is equal to T2.

Referring to FIG. 2C, if T2 is earlier than T1, the second delay can be extended such that action time of the CSC indicating the candidate cell becomes T2′, where T2′ is equal to T1.

In some implementations, if the UE 102 receives beam indication of a candidate cell and a CSC indicating the candidate cell (could be at the same time or different time), and if T1 is later than T2 or later than completion of the lower layer centric mobility, the UE determines a default beam and/or default pathloss reference signal to communicate with the network entity 104 in the candidate cell before T1.

In some implementations, the UE 102 determines a default beam to communicate with the network entity 104 in the target cell if no beam indication is received before or after the completion of lower layer centric mobility procedure. In some implementations, the UE 102 determines a default pathloss reference signal for uplink power control to transmit the uplink signal toward the target cell.

In some implementations, the UE 102 might determine the default beam and/or default pathloss reference signal based on one of the followings: an active TCI or a known TCI for the target cell with the lowest TCI state ID or the lowest TCI codepoint ID, and/or a TCI with source RS or reference RS, which is the first RS reported in the most recent beam report (e.g., a CSI report for RSRP or SINR) for the target cell, and/or a TCI with source RS or reference RS, which is the RS with the best measurement result reported in the most recent beam report (e.g., a CSI report for RSRP or SINR) for the target cell, and/or quasi co-location (QCL) assumption from a SSB of the target cell, where the SSB is randomly selected by the UE or the SSB is associated with the most recent PRACH that the UE transmitted toward the target cell (i.e., the candidate cell indicated by the CSC) or the SSB where the UE decoded master information block (MIB) for the target cell (i.e., the candidate cell indicated by the CSC).

In some implementations, if T1 is different from the timing of completing the lower layer centric mobility, the first delay can be extended such that T1″ (with extended value of the first delay) is equal to the timing of completing the lower layer centric mobility. The timing of completing the lower layer centric mobility might be different from T2.

In some implementations, if T1 is earlier than the timing of completing the lower layer centric mobility, the first delay can be extended such that action time of beam indication for the target cell becomes T1″, where T1″ is equal to the timing of completing the lower layer centric mobility.

In some implementations, action time of beam indication for the target cell might be different from that of beam indication for the source cell. In some implementations, the way/rule to determine time delay of beam indication for candidate cell(s) (e.g., the first time delay) may be different from that of beam indication for the serving cell or the source cell (i.e., the first/second application time period and the first/second slot). In some implementations, the value of the first time delay might be different from that of time delay of beam indication for the serving cell (or the source cell).

In some implementations, upon receiving a beam indication, the UE 102 determines which time delay to apply and/or when to apply, based on whether the beam indication is intended for the candidate cell(s) or the serving cell (or the source cell). For example, if the beam indication is intended for candidate cell(s) or if the UE 102 determines that the beam indication is intended for candidate cell(s), the UE 102 applies the time delay of beam indication for the candidate cell (i.e., the first time delay). If the beam indication is intended for the serving cell (or the source cell) or if the UE 102 determines that the beam indication is intended for the serving cell (or the source cell), the UE 102 applies the time delay of beam indication for the serving cell (or the source cell) (i.e., the first/second application time period and the first/second slot). Note that different time delay of beam indication and/or different time to apply time delay of beam indication can result in different action time.

In some implementations, if the UE 102 receives 506 a beam indication via a MAC-CE, the UE 102 determines 509 whether the beam indication is intended for the candidate cell(s) (or the target cell) or the current serving cell (or source cell), based on one of the followings: If the MAC-CE indicates a TCI state configured in candidate cell configuration(s) or configured for a candidate cell or associated with a candidate cell, the beam indication is intended for candidate cell(s) (or target cell); otherwise, the beam indication is intended for the serving cell (or source cell), and/or whether the MAC-CE indicates the beam indication is intended for candidate cell(s) (or target cell) or the serving cell (or source cell), e.g., via a bit or field or a byte in the MAC-CE, and/or whether a DCI scheduling the MAC-CE indicates the beam indication is intended for candidate cell(s) (or target cell) or the serving cell (or source cell), e.g., via a bit or field in the DCI.

In some implementations, if the UE 102 receives a beam indication via a DCI, the UE 102 determines whether the beam indication is intended for candidate cell(s) (or target cell) or the current serving cell (or source cell), based on one of the followings: whether the DCI schedules a CSC; if yes, the beam indication is intended for candidate cell(s) (or target cell), otherwise, it's for the serving cell (or source cell), and/or whether the DCI indicates the beam indication is intended for candidate cell(s) (or target cell) or the serving cell (or source cell), e.g., via a bit or field in the DCI.

In some implementations, action time of a CSC might be different from that of a MAC-CE not carrying CSC. In some implementations, the rule to determine time delay of the CSC (e.g., the second time delay) might be different from that of a MAC-CE not including CSC. In some implementations, the value of the second time delay might be different from that of time delay of a MAC-CE not carrying CSC.

In some implementations, upon receiving a MAC-CE, the UE 102 determines which time delay to apply and/or when to apply, based on whether the MAC-CE is a CSC. If the MAC-CE includes a CSC, the UE 102 applies the time delay of a CSC (i.e., the second time delay). If the MAC-CE does not include a CSC, the UE 102 applies the time delay of a MAC-CE for the serving cell or the source cell (e.g., 3 millisecond). Note that different time delay and/or different time to apply time delay of a MAC-CE (e.g., CSC or a MAC-CE other than CSCS) can result in different action time.

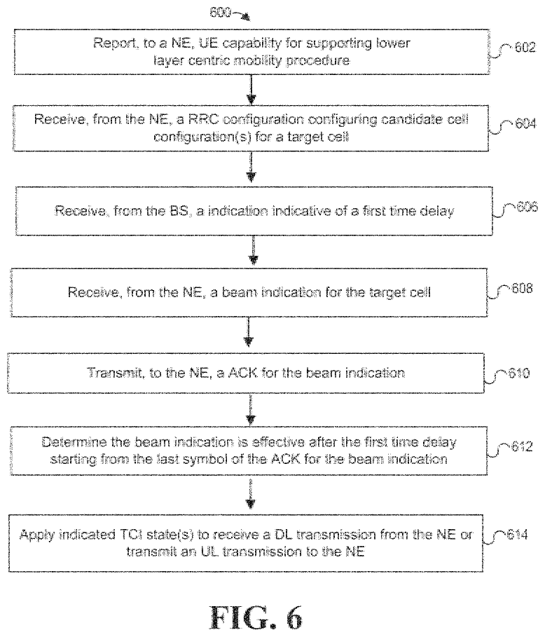

FIG. 5 describes a signaling diagram of an example scenario in which a UE and network entity exchange messages and implement procedures for supporting the lower layer centric mobility procedure, whereas FIG. 6 describes a method of the lower layer centric mobility procedure from a UE-side of the wireless communication link.

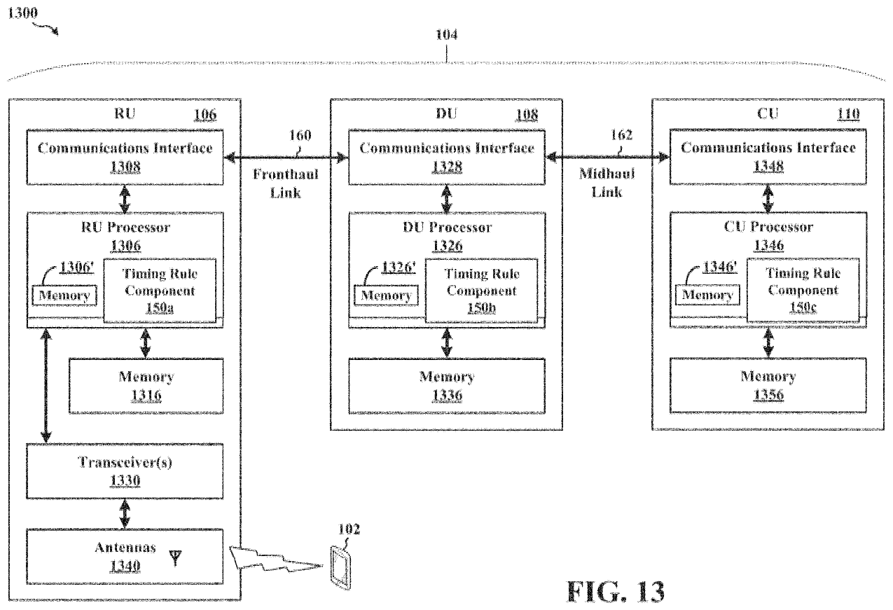

Now turning to FIG. 6 which illustrates an example method 600 for the lower layer centric mobility procedure implemented in the UE. The method 600 can be implemented by UE 102 and network entity 104 depicted in FIG. 1. With reference to FIGS. 1 and 13, the method may be performed by the UE 102, the UE apparatus 1300, etc., which may include the memory 1324′ and which may correspond to the entire UE 102 or the UE apparatus 1300, or a component of the UE 102 or the UE apparatus 1300, such as the wireless baseband processor 1324, and/or the application processor 1306.

Referring to FIG. 6, the method 600 begins at block 602 where the UE 102 may transmit a UE capability report message for supporting lower layer centric mobility procedure (events 302, 402, 502). For example, referring to FIG. 3, the UE 102 transmits 302 a UE capability report for supporting lower layer centric mobility procedure.

Next, at block 604, the UE 102 receives, from the network entity 104, a RRC configuration configuring candidate cell configurations for a target cell. For example, referring to FIG. 3, the UE 102 receives 304 a RRC configuration configuring candidate cell configurations for a target cell.

At block 606, the UE 102 receives, from the network entity 104, an indication indicative of a first time delay. For example, referring to FIG. 3, the UE 102 receives 306 a beam indication to indicate TCI state(s) applied/used for a target cell from configured candidate cell(s).

At block 608, the UE 102 receives, from the network entity 104, a beam indication for the target cell. For example, referring to FIG. 3, the UE 102 receives 306 a beam indication to indicate TCI state(s) applied/used for a target cell from configured candidate cell(s).

At block 610, the UE 102 transmits, to the network entity 104, an acknowledgement for the beam indication. For example, referring to FIG. 3, the UE 102 transmits 308 an acknowledgement for the beam indication.

At block 612, the UE 102 determines the beam indication is effective after the first time delay starting from the last symbol of the ACK for the beam indication. For example, referring to FIG. 3, in block 314, the beam indication is effective after a first time delay. The CSC is effective after a second time delay. The network entity 104 or the UE 102 may indicate the first time delay or the second time delay.

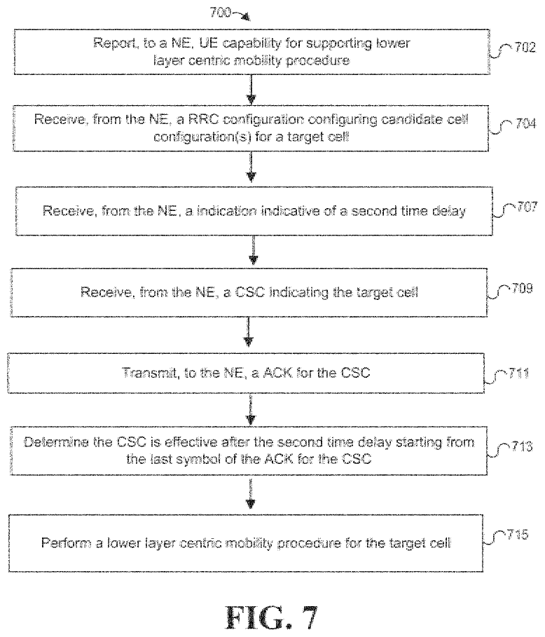

At block 614, the UE 102 applies indicated TCI state(s) to receive a DL transmission from the network entity 104 or transmit an UL transmission to the network entity 104. FIG. 6 describes a method from a UE-side of a wireless communication link, whereas FIG. 7 describes another method from a UE-side of the wireless communication link.

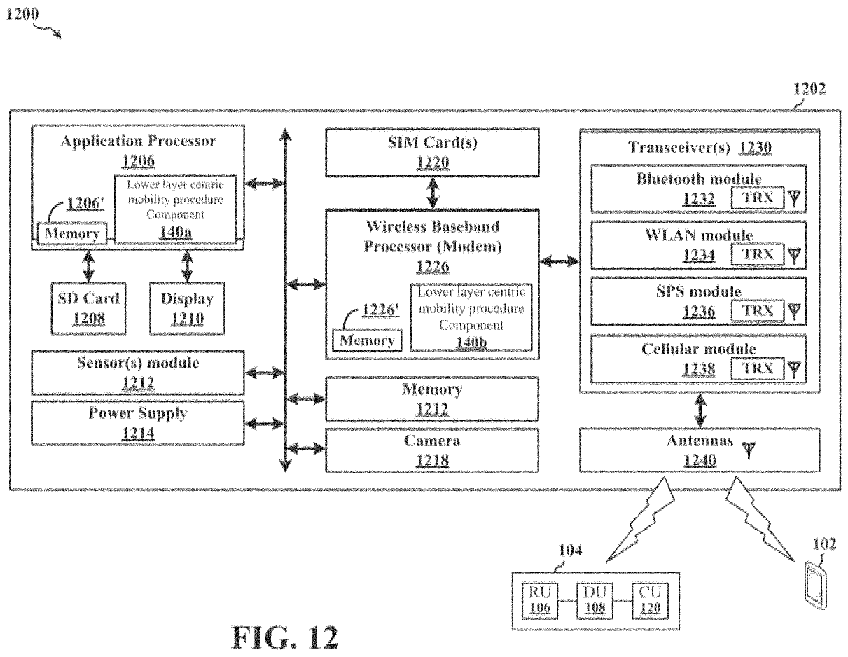

Now turning to FIG. 7 which illustrates an example method 700 for supporting lower layer centric mobility procedure implemented in the UE. The method 700 can be implemented by UE 102 and network entity 104 depicted in FIG. 1. With reference to FIGS. 1 and 12, the method may be performed by the UE 102, the UE apparatus 1200, etc., which may include the memory 1224′ and which may correspond to the entire UE 102 or the UE apparatus 1200, or a component of the UE 102 or the UE apparatus 1200, such as the wireless baseband processor 1224, and/or the application processor 1206.

Referring to FIG. 7, the method 700 begins at block 702 where the UE 102 may transmit a UE capability report message for supporting lower layer centric mobility procedure (events 302, 402, 502). For example, referring to FIG. 3, the UE 102 transmits 302 a UE capability report for supporting lower layer centric mobility procedure.

Next, at block 704, the UE 102 receives, from the network entity 104, a RRC configuration configuring candidate cell configurations for a target cell. For example, referring to FIG. 3, the UE 102 receives 304 a RRC configuration configuring candidate cell configurations for a target cell.

Next, at block 707, the UE 102 receives, from the network entity 104, an indication indicative of a second time delay. For example, referring to FIG. 3, the UE 102 receives 306 a beam indication to indicate TCI state(s) applied/used for a target cell from configured candidate cell(s).

At block 709, the UE 102 receives, from the network entity 104, a CSC indicating the target cell. For example, referring to FIG. 3, the UE 102 receives 310 a CSC indicating the target cell.

At block 711, the UE 102 transmits, from the network entity 104, an acknowledgement for the CSC. For example, referring to FIG. 3, the UE 102 transmits 312 a CSC indicating the acknowledgement for the CSC.

At block 713, the UE 102 determines the CSC is effective after the second time delay starting from the last symbol of the ACK for the CSC. For example, referring to FIG. 3, in block 314, the beam indication is effective after a first time delay. The CSC is effective after a second time delay. The network entity 104 or the UE 102 may indicate the first time delay or the second time delay.

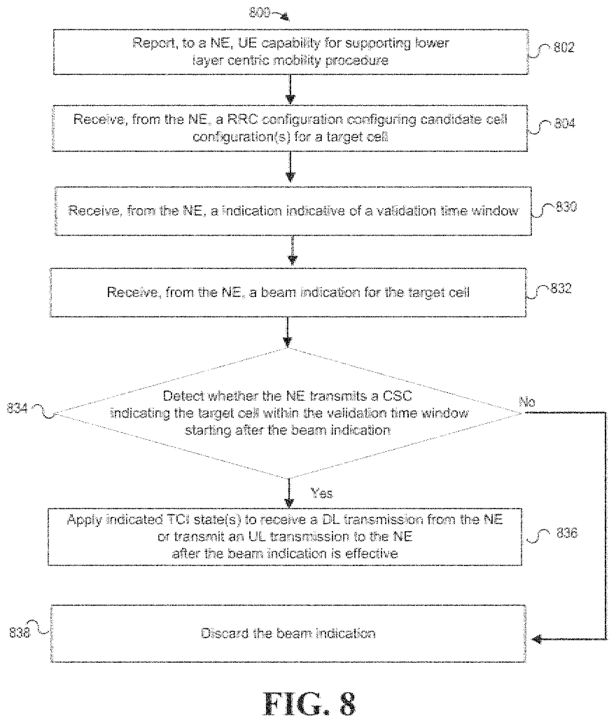

At block 715, the UE 102 perform a lower layer centric mobility procedure for the target cell. FIG. 7 describes a method from a UE-side of a wireless communication link, whereas FIG. 8 describes another method from a UE-side of the wireless communication link.

Now turning to FIG. 8 which illustrates an example method 800 for supporting lower layer centric mobility procedure implemented in the UE. The method 800 can be implemented by UE 102 and network entity 104 depicted in FIG. 1. With reference to FIGS. 1 and 12, the method may be performed by the UE 102, the UE apparatus 1200, etc., which may include the memory 1224′ and which may correspond to the entire UE 102 or the UE apparatus 1200, or a component of the UE 102 or the UE apparatus 1200, such as the wireless baseband processor 1224, and/or the application processor 1206.

At block 802, the UE 102 reports, to a network entity 104, a UE capability for supporting lower layer centric mobility procedure. For example, referring to FIG. 3, the UE 102 transmits 302 a UE capability report for supporting lower layer centric mobility procedure.

At block 804, the UE 102 receives, from the network entity 104, a RRC configuration configuring candidate cell configuration(s) for a target cell. For example, referring to FIG. 3, the UE 102 receives 304 a RRC configuration configuring candidate cell configurations for a target cell.

At block 830, the UE 102 receives, from the network entity 104, an indication indicative of a validation time window.

At block 832, the UE 102 receives, from the network entity 104, a beam indication for the target cell. For example, referring to FIG. 3, the UE 102 receives 310 a CSC indicating the target cell.

At block 834, the UE 102 detects whether the network entity 104 transmits a CSC indicating the target cell within the validation time window starting after the beam indication.

If the UE 102 detects the network entity 104 transmits a CSC indicating the target cell within the validation time window, the UE applies the indicated TCI state(s) to receive a downlink, DL, transmission from the network entity 104 or transmit an uplink, UL, transmission to the network entity 104 after the beam indication is effective.

If the UE 102 does not detect the network entity 104 transmits a CSC indicating the target cell within the validation time window, the UE discards the beam indication.

In some implementations, the network entity 104 might indicate or configure the UE a validation time window. If the UE 102 receives a beam indication for a candidate cell, and does not detect or receive a CSC indicating the candidate cell during the validation time window, the UE 102 might release or discard information indicated by the beam indication for the candidate cell. If the UE 102 receives a CSC indicating a candidate cell, and does not detect or receive a beam indication for the candidate cell during the validation time window, the UE 102 might release or discard information indicated by the CSC. In some other implementations, if the UE 102 receives a CSC indicating a candidate cell and receives a control signaling enabling or indicating the UE to determine or derive a TCI state (or a default beam) for the candidate cell, and does not detect or receive a beam indication for the candidate cell during the validation time window, the UE 102 applies the indicated CSC.

In some implementations, the timing to start the validation time window for the beam indication might be based one of the followings: after Y1 symbol(s) (or slot(s) or millisecond) after the first/last symbol of PDCCH/PDSCH carrying the beam indication for a candidate cell. In such case, Y1 might be predefined, e.g., 0, or reported by the UE via UE capability report, or configured by the network entity 104 via higher layer signaling, e.g., RRC signaling, or indicated by the network entity 104 via a MAC-CE or DCI; and/or after Y2 symbol(s) (or slot(s) or millisecond) after transmitting ACK of PDCCH/PDSCH carrying the beam indication for a candidate cell. In such case, Y2 might be predefined, e.g., 0, or reported by the UE via UE capability report, or configured by the network entity 104 via higher layer signaling, e.g., RRC signaling, or indicated by the network entity 104 via a MAC-CE or DCI.

In some implementations, the timing to start the validation time window for the CSC might be based one of the followings: after Z1 symbol(s) (or slot(s) or millisecond) after the first/last symbol of the PDSCH or MAC-CE carrying the CSC.

In such case, Z1 might be predefined, e.g., 0, or reported by the UE via UE capability report, or configured by the network entity 104 via higher layer signaling, e.g., RRC signaling, or indicated by the network entity 104 via a MAC-CE or DCI, after Z2 symbol(s) (or slot(s) or millisecond) after transmitting ACK of the PDSCH or MAC-CE carrying the CSC. In such case, Z2 might be predefined, e.g., 0, or reported by the UE via UE capability report, or configured by the network entity 104 via higher layer signaling, e.g., RRC signaling, or indicated by the network entity 104 via a MAC-CE or DCI.

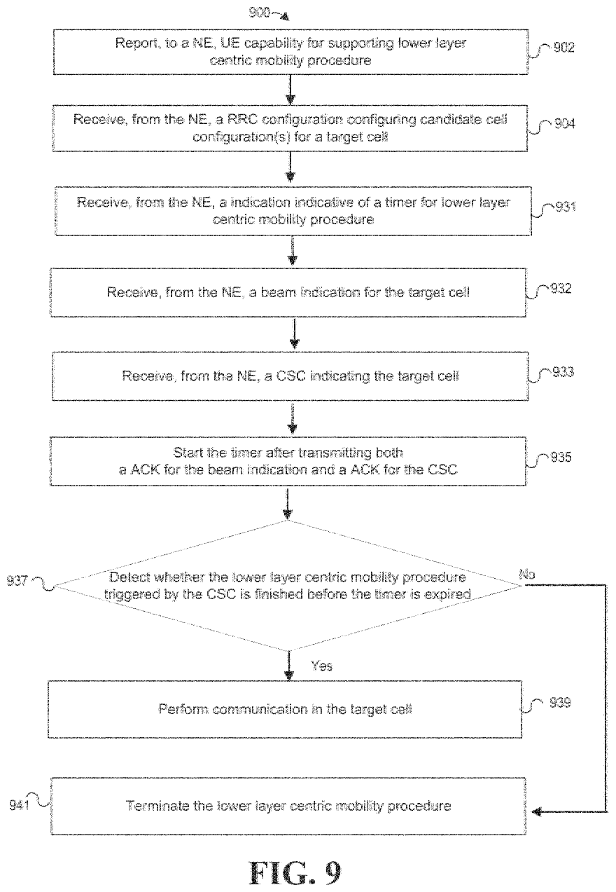

FIG. 8 describes a method from a UE-side of a wireless communication link, whereas FIG. 9 describes another method from a UE-side of the wireless communication link.

Now turning to FIG. 9 which illustrates an example method 900 for supporting lower layer centric mobility procedure implemented in the UE. The method 800 can be implemented by UE 102 and network entity 104 depicted in FIG. 1. With reference to FIGS. 1 and 12, the method may be performed by the UE 102, the UE apparatus 1200, etc., which may include the memory 1224′ and which may correspond to the entire UE 102 or the UE apparatus 1200, or a component of the UE 102 or the UE apparatus 1200, such as the wireless baseband processor 1224, and/or the application processor 1206.

At block 902, the UE 102 reports, to the network entity 104, a UE capability for supporting lower layer centric mobility procedure. For example, referring to FIG. 3, the UE 102 transmits 302 a UE capability report for supporting lower layer centric mobility procedure.

At block 904, the UE 102 receives, from the network entity 104, a RRC configuration configuring candidate cell configuration(s) for a target cell. For example, referring to FIG. 3, the UE 102 receives 304 a RRC configuration configuring candidate cell configurations for a target cell.

At block 931, the UE 102 receives, from the network entity 104, an indication indicative of a timer for lower layer centric mobility procedure.

At block 932, the UE 102 receives, from the network entity 104, a beam indication for the target cell. For example, referring to FIG. 3, the UE 102 receives 306 a beam indication to indicate TCI state(s) applied/used for a target cell from configured candidate cell(s).

At block 933, the UE 102 receives, from the network entity 104, a CSC indicating the target cell. For example, referring to FIG. 3, the UE 102 receives 310 a CSC indicating the target cell.

At block 935, the UE 102 starts the timer after transmitting both an ACK for the beam indication and a ACK for the CSC.

At block 937, the UE 102 detects whether the lower layer centric mobility procedure triggered by the CSC is finished before the timer is expired.

If the UE 102 detects the lower layer centric mobility procedure triggered by the CSC is finished before the timer is expired, at block 939, the UE 102 performs communication in the target cell.

If the UE 102 does not detect the lower layer centric mobility procedure triggered by the CSC is finished before the timer is expired, at block 941, the UE 102 terminates the lower layer centric mobility procedure.

In some implementations, if the UE 102 receives a beam indication for a candidate cell, and does not detect or receive a CSC indicating the candidate cell, the UE might determine whether to release or discard or keep information indicated by the beam indication for the candidate cell.

In some implementations, if the UE 102 receives a CSC indicating a candidate cell, and does not detect or receive a beam indication for the candidate cell, the UE 102 might determine whether to release or discard or keep information indicated by the CSC.

In some implementations, the validation time window may be a time, or a timer, or a time duration, or a counter.

In some implementations, the network entity 104 may indicate or configure the UE 102 a first timer. The first time may include an LTM timer used to supervise the LTM procedure. The network entity 104 and/or the UE 102 uses the first timer to supervise the lower layer centric mobility procedure triggered by the CSC scheduled by the second DCI. If a lower layer centric mobility procedure for the target cell (i.e., the candidate cell indicated by the CSC) cannot be completed before the first timer is ended, the UE 102 might terminate the lower layer centric mobility procedure. If the UE 102 terminates the lower layer centric mobility procedure, the UE 102 might report it to the network entity 104 or lower/higher layer of the UE 102.

In some implementations, the network entity 104 might indicate or configure the UE 102 a second timer. The second timer may include a beam indication timer, used to supervise the beam indication process. The network entity 104 and/or the UE 102 uses the second timer to supervise a beam switching/tracking process triggered by a beam indication for the target cell (i.e., the candidate cell indicated by a CSC). If the beam switching/tracking process cannot be completed before the second timer is ended, the UE 102 might terminate the beam switching/tracking process. If the UE 102 terminates the beam switching/tracking process, the UE 102 might report it to the network entity 104 or lower/higher layer of the UE 102. If the UE 102 terminates the beam switching/tracking process, the UE 102 might return to use previous beam or TCI state in the serving cell (or the source cell). In some implementations, the network entity 104 and the UE 102 determines the previous TCI state(s) as known TCI state(s) and applies the known TCI switching delay for the previous TCI state(s) when switching to the previous TCI state(s). In some other implementations, the network entity 104 and the UE determines the previous TCI state(s) as unknown TCI state(s) and applies the unknown TCI switching delay for the previous TCI state(s) when switching to the previous TCI state(s).

In some implementations, the UE 102 might start or restart the first timer at one of following timing: after the UE 102 receives a CSC or transmits an ACK for the CSC, and/or after the UE 102 receives beam indication for a candidate cell indicated by a CSC or transmits an ACK for beam indication for a candidate cell indicated by a CSC, and/or after the UE 102 receives (or transmits ACK(s) for) both a CSC and beam indication for the candidate cell indicated by the CSC. Such case might imply that the UE 102 does not start or restart the first timer if the UE 102 only receives (or transmits ACK for) one of a CSC or a beam indication applicable for the candidate cell indicated by the CSC.

In some implementations, the UE 102 might start or restart the second timer at one of following timing: after the UE 102 receives a beam indication for a candidate cell indicated by a CSC or transmits an ACK for beam indication for a candidate cell indicated by a CSC, and/or after the UE 102 receives a CSC or transmits an ACK for the CSC, and/or after the UE 102 receives (or transmits ACK(s) for) both a CSC and beam indication for the candidate cell indicated by the CSC. Such case might imply that the UE 102 does not start or restart the second timer if only receiving (or transmitting ACK for) one of a CSC or a beam indication applicable for the candidate cell indicated by the CSC.

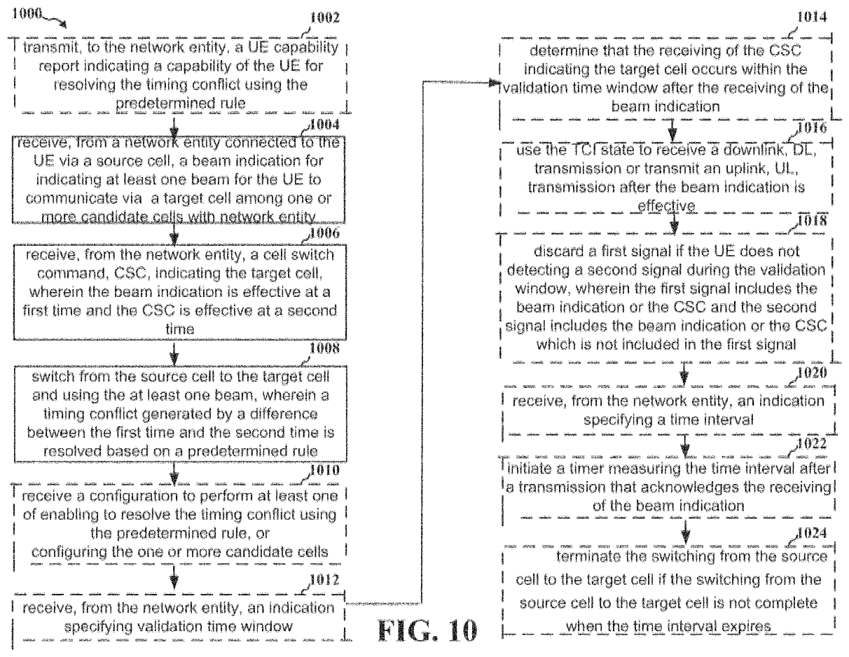

FIG. 10 illustrates a flowchart 1000 of a method of wireless communication at a UE. With reference to FIGS. 1 and 12, the method may be performed by the UE 102, the UE apparatus 1200, etc., which may include the memory 1224′ and which may correspond to the entire UE 102 or the UE apparatus 1200, or a component of the UE 102 or the UE apparatus 1200, such as the wireless baseband processor 1224, and/or the application processor 1206.

The UE 102 transmits 1002, to a network entity, a UE capability report indicating a capability of a UE for resolving the timing conflict using the predetermined rule. For example, referring to FIG. 3, the UE 102 transmits 302 a UE capability report for supporting lower layer centric mobility procedure.

The UE 102, receives 1004, from a network entity 104 connected to the UE 102 via a source cell, a beam indication for indicating at least one beam for the UE to communicate via a target cell among one or more candidate cells with the network entity 104. For example, referring to FIG. 3, the UE 102 receives 306 a beam indication to indicate TCI state(s) applied/used for a target cell from configured candidate cell(s).

The UE 102 receives 1006, from the network entity 104, a cell switch command, CSC, indicating the target cell, wherein the beam indication is effective at a first time and the CSC is effective at a second time. For example, referring to FIG. 3, the UE 102 receives 310 a CSC indicating the target cell.

The UE 102 switches 1008 from the source cell to the target cell and using the at least one beam. A timing conflict is generated by a difference between the first time and the second time is resolved based on a predetermined rule.

The UE 102 receives 1010, from the network entity 104, a configuration to perform at least one of enabling to resolve the timing conflict using the predetermined rule, or configuring the one or more candidate cells. For example, referring to FIG. 3, the UE 102 receives 304 a RRC configuration configuring candidate cell configurations for a target cell.

The UE 102 receives 1012, from the network entity 104, an indication specifying a validation time window.

The UE 12 determines 1014 that the receiving of the CSC indicating the target cell occurs within the validation time window after the receiving of the beam indication.

The UE 102 uses 1016 the TCI state to receive a downlink, DL, transmission or to transmit an uplink, UL, transmission after the beam indication is effective.

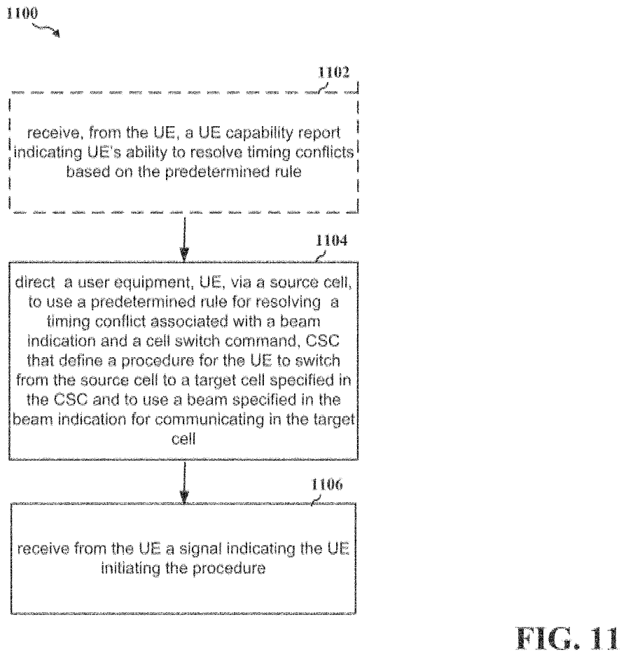

The UE 102 discards 1018 a first signal if the UE 102 does not detect a second signal during the validation window, wherein the first signal includes the beam indication or the CSC and the second signal includes the beam indication or the CSC which is not included in the first signal. FIG. 10 describes a method from a UE-side of a wireless communication link, whereas FIG. 11 describes a method from a network-side of the wireless communication link.

The UE 102 receives 1020, from the network entity 104, an indication specifying a time interval.

The UE 102 initiates 1022 a timer measuring the time interval after a transmission that acknowledges the receiving of the beam indication.

The UE 102 terminates 1024 the switching from the source cell to the target cell if the switching from the source cell to the target cell is not complete when the time interval expires.

FIG. 11 is a flowchart 1100 of a method of wireless communication at a network entity. With reference to FIGS. 1 and 13, the method may be performed by one or more network entities 104, which may correspond to a base station or a unit of the base station, such as the RU 106, the DU 108, the CU 110, an RU processor 1306, a DU processor 1326, a CU processor 1346, etc. The one or more network entities 104 may include memory 1306′/1326′/1346′, which may correspond to an entirety of the one or more network entities 104, or a component of the one or more network entities 104, such as the RU processor 1306, the DU processor 1326, or the CU processor 1346.

The network entity 104 receives 1102, from a UE 102, a UE capability report indicating a capability of the UE to resolve timing conflicts based on the predetermined rule. For example, referring to FIG. 3, the network entity 104, receives 302, from the UE 102, a UE capability report for supporting lower layer centric mobility procedure.

The network entity 104 directs 1104 a UE 102, via a source cell, to use a predetermined rule for resolving a timing conflict associated with a beam indication and a cell switch command, CSC that define a procedure for the UE to switch from the source cell to a target cell specified in the CSC and to use a beam specified in the beam indication for communicating in the target cell. For example, referring to FIG. 3, the network entity 104, transmits 306, to the UE 102, a beam indication to indicate TCI state(s) applied/used for a target cell from configured candidate cell(s).

The network entity 104 receives 1106 from the UE a signal indicating the UE initiating the procedure. For example, referring to FIG. 3, the network entity 104, receives 312, from the UE 102, an ACK for the CSC.

It is noted that throughout this disclosure, a neighboring cell can be referred to or replaced with one or some of the followings: (1) an on-serving cell, (2) a cell with a physical cell ID (PCI) different that of the serving cell, (3) a TRP associated with a PCI different from that of the serving cell.

It is noted that throughout this disclosure, action time of a signal could mean the actual timing when the signal is applicable or takes effect, which could be later than the timing of receiving the signal.

It is noted that throughout this disclosure, a joint TCI state can be referred to or replaced with at least one of the followings: (1) a beam applicable for both one or more DL and UL transmission(s), e.g., one or more DL channel, UL channel, DL RS and/or UL RS, (2) a spatial filter for transmission and/or reception, (3) a spatial parameters for transmission and/or reception, (4) a spatial relationship for transmission and/or reception, (5) a spatial assumption for transmission and/or reception.

It is noted that throughout this disclosure, a “DL mode” or a “DL-only TCI state mode” could mean or be referred to at least one of the followings: (1) TCI field(s) or indicated TCI state(s) in a DCI format may refer/map to DL TCI state pool (joint TCI state pool), and/or (2) beam indication(s) or indicated TCI state(s) are applied for (only) receiving DL transmission.

A UE apparatus 1202, as described in FIG. 12, may perform the method of flowchart 1000. The one or more network entities 104, as described in FIG. 13, may perform the method of flowchart 1100.

FIG. 12 is a diagram 1200 illustrating an example of a hardware implementation for a UE apparatus 1202. The UE apparatus 1202 may be the UE 102, a component of the UE 102, or may implement UE functionality. The UE apparatus 1202 may include an application processor 1206, which may have on-chip memory 1206′. In examples, the application processor 1206 may be coupled to a secure digital (SD) card 1208 and/or a display 1210. The application processor 1206 may also be coupled to a sensor(s) module 1212, a power supply 1214, an additional module of memory 1216, a camera 1218, and/or other related components. For example, the sensor(s) module 1212 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 1202 may further include a wireless baseband processor 1226, which may be referred to as a modem. The wireless baseband processor 1226 may have on-chip memory 1226′. Along with, and similar to, the application processor 1206, the wireless baseband processor 1226 may also be coupled to the sensor(s) module 1212, the power supply 1214, the additional module of memory 1216, the camera 1218, and/or other related components. The wireless baseband processor 1226 may be additionally coupled to one or more subscriber identity module (SIM) card(s) 1220 and/or one or more transceivers 1230 (e.g., wireless RF transceivers).

Within the one or more transceivers 1230, the UE apparatus 1202 may include a Bluetooth module 1232, a WLAN module 1234, an SPS module 1236 (e.g., GNSS module), and/or a cellular module 1238. The Bluetooth module 1232, the WLAN module 1234, the SPS module 1236, and the cellular module 1238 may each include an on-chip transceiver (TRX), or in some cases, just a transmitter (TX) or just a receiver (RX). The Bluetooth module 1232, the WLAN module 1234, the SPS module 1236, and the cellular module 1238 may each include dedicated antennas and/or utilize antennas 1240 for communication with one or more other nodes. For example, the UE apparatus 1202 can communicate through the transceiver(s) 1230 via the antennas 1240 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1226 and the application processor 1206 may each include a computer-readable medium/memory 1226′, 1206′, respectively. The additional module of memory 1216 may also be considered a computer-readable medium/memory. Each computer-readable medium/memory 1226′, 1206′, 1216 may be non-transitory. The wireless baseband processor 1226 and the application processor 1206 may each be responsible for general processing, including execution of software stored on the computer-readable medium/memory 1226′, 1206′, 1216. The software, when executed by the wireless baseband processor 1226/application processor 1206, causes the wireless baseband processor 1226/application processor 1206 to perform the various functions described herein. The computer-readable medium/memory may also be used for storing data that is manipulated by the wireless baseband processor 1226/application processor 1206 when executing the software. The wireless baseband processor 1226/application processor 1206 may be a component of the UE 102. The UE apparatus 1202 may be a processor chip (e.g., modem and/or application) and include just the wireless baseband processor 1226 and/or the application processor 1206. In other examples, the UE apparatus 1202 may be the entire UE 102 and include the additional modules of the apparatus 1202.

As discussed, the lower layer centric mobility procedure component 140 is configured to receive, from a network entity connected to the UE via a source cell, a beam indication for at least one beam usable by the UE to communicate via a target cell among one or more candidate cells with the network entity; receiving, from the network entity, a cell switch command, CSC, indicating the target cell, wherein the beam indication is effective at a first time and the CSC is effective at a second time; and switching from the source cell to the target cell and using the at least one beam, wherein a timing conflict generated by a difference between the first time and the second time is resolved based on a predetermined rule.

The lower layer centric mobility procedure component 140 may be within the application processor 1206 (e.g., at 140a), the wireless baseband processor 1226 (e.g., at 140b), or both the application processor 1206 and the wireless baseband processor 1226. The lower layer centric mobility procedure component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 13 is a diagram 1300 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1346, which may have on-chip memory 1346′. In some aspects, the CU 110 may further include an additional module of memory 1356 and/or a communications interface 1348, both of which may be coupled to the CU processor 1346. The CU 110 can communicate with the DU 108 through a midhaul link 162, such as an F1 interface between the communications interface 1348 of the CU 110 and a communications interface 1328 of the DU 108.

The DU 108 may include a DU processor 1326, which may have on-chip memory 1326′. In some aspects, the DU 108 may further include an additional module of memory 1336 and/or the communications interface 1328, both of which may be coupled to the DU processor 1326. The DU 108 can communicate with the RU 106 through a fronthaul link 160 between the communications interface 1328 of the DU 108 and a communications interface 1308 of the RU 106.

The RU 106 may include an RU processor 1306, which may have on-chip memory 1306′. In some aspects, the RU 106 may further include an additional module of memory 1316, the communications interface 1308, and one or more transceivers 1330, all of which may be coupled to the RU processor 1306. The RU 106 may further include antennas 1340, which may be coupled to the one or more transceivers 1330, such that the RU 106 can communicate through the one or more transceivers 1330 via the antennas 1340 with the UE 102.

The on-chip memory 1306′, 1326′, 1346′ and the additional modules of memory 1316, 1336, 1356 may each be considered a computer-readable medium/memory. Each computer-readable medium/memory may be non-transitory. Each of the processors 1306, 1326, 1346 is responsible for general processing, including execution of software stored on the computer-readable medium/memory. The software, when executed by the corresponding processor(s) 1306, 1326, 1346 causes the processor(s) 1306, 1326, 1346 to perform the various functions described herein. The computer-readable medium/memory may also be used for storing data that is manipulated by the processor(s) 1306, 1326, 1346 when executing the software. In examples, the timing rule component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106. As discussed, the timing rule component 150 is configured to direct a user equipment, UE, via a source cell, to use a predetermined rule for resolving a timing conflict associated with a beam indication and a cell switch command, CSC that define a procedure for the UE to switch from the source cell to a target cell specified in the CSC and to use a beam specified in the beam indication for communicating in the target cell; and to receive from the UE a signal indicating the UE initiating the procedure.

The timing rule component 150 may be within one or more processors of the one or more network entities 104, such as the RU processor 1306 (e.g., at 150a), the DU processor 1326 (e.g., at 150b), and/or the CU processor 1346 (e.g., at 150c). The timing rule component 150a-150c may be one or more hardware components specifically configured to carry out the stated processes/algorithm, implemented by one or more processors 1306, 1326, 1346 configured to perform the stated processes/algorithm, stored within a computer-readable medium for implementation by the one or more processors 1306, 1326, 1346, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including:
receiving, from a network entity connected to the UE via a source cell, a beam indication for indicating at least one beam for the UE to communicate via a target cell among one or more candidate cells with the network entity; receiving, from the network entity, a cell switch command, CSC, indicating the target cell, wherein the beam indication is effective at a first time and the CSC is effective at a second time; and switching from the source cell to the target cell and using the at least one beam, wherein a timing conflict generated by a difference between the first time and the second time is resolved based on a predetermined rule.

Example 2 may be combined with Example 1 and includes that the predetermined rule requires using a flexible action time instead of one of the first time and the second time.

Example 3 may be combined with Example 1 and includes that the predetermined rule extends the shorter among the first time and the second time to match the longer among the first time and the second time.

Example 4 may be combined with Example 1 and includes that the predetermined rule includes using a default beam to initiate the switching until the first time if the first time is later than the second time.

Example 5 may be combined with Example 1 and includes that the predetermined rule is the first time coincides with a third time when the switching is completed.

Example 6 may be combined with Example 1 and the further includes transmitting, to the network entity, a UE capability report indicating a capability of the UE for resolving the timing conflict using the predetermined rule.

Example 7 may be combined with Example 6 and further includes that the UE capability report specifies the predetermined rule.

Example 8 may be combined with any Examples 1-7 and further includes receiving a configuration to perform at least one of enabling to resolve the timing conflict using the predetermined rule, or configuring the one or more candidate cells.

Example 9 may be combined with any Examples 1-8 and further includes that a value of the first time depends on whether the at least one beam is used for communicating with the source cell or the target cell.

Example 10 may be combined with Example 9 and further includes receiving of the beam indication includes decoding a Medium Access Control-Control Example, MAC-CE.

Example 11 may be combined with any Examples 1-10 and further includes that the first time is determined by applying a first time delay to a time of transmitting a last symbol of a message that acknowledges the receiving of the beam indication.

Example 12 may be combined with any Examples 1-11 and further includes receiving, from the network entity, an indication specifying a validation time window; and determining that the receiving of the CSC indicating the target cell occurs within the validation time window after the receiving of the beam indication.

Example 13 may be combined with Example 12 and further includes that the beam indication indicates the at least one beam using transmission configuration indicator, TCI, state, further including: using the TCI state to receive a downlink, DL, transmission or to transmit an uplink, UL, transmission after the beam indication is effective.

Example 14 may be combined with Example 13 and further includes discarding a first signal if the UE does not detecting a second signal during the validation window, wherein the first signal includes the beam indication or the CSC and the second signal includes the beam indication or the CSC which is not included in the first signal.

Example 15 may be combined with any Examples 1-13 and further includes receiving, from the network entity, an indication specifying a time interval; initiating a timer measuring the time interval after a transmission that acknowledges the receiving of the beam indication; and terminating the switching from the source cell to the target cell if the switching from the source cell to the target cell is not complete when the time interval expires.

Example 16 is a method of wireless communication at a network entity, including: directing a user equipment, UE, via a source cell, to use a predetermined rule for resolving a timing conflict associated with a beam indication and a cell switch command, CSC, that define a procedure for the UE to switch from communicating via the source cell to communicating via a target cell specified in the CSC and to use a beam specified in the beam indication for communicating via the target cell; and
receiving from the UE a signal indicating the UE initiating the procedure.

Example 17 may be combined with Example 16 and further includes receiving, from the UE, a UE capability report indicating UE's ability to resolve timing conflicts based on the predetermined rule.

Example 18 is an apparatus for wireless communication for implementing a method as in any of examples 1-17.

Example 19 is an apparatus for wireless communication including means for implementing a method as in any of examples 1-17.

Example 20 is a non-transitory computer-readable medium storing computer executable code, the code when executed by a processor causes the processor to implement a method as in any of examples 1-17.

1. A method of wireless communication at a user equipment (UE), comprising:
receiving, from a network entity connected to the UE via a source cell, a beam indication for indicating at least one beam for the UE to communicate via a target cell among one or more candidate cells with the network entity;
receiving, from the network entity, a cell switch command (CSC) indicating the target cell, wherein the beam indication is effective at a first time and the CSC is effective at a second time, the beam indication indicating the at least one beam using transmission configuration indicator (TCI) state to receive a downlink (DL) transmission or to transmit an uplink (UL) transmission; and
switching from the source cell to the target cell and using the at least one beam, wherein a timing conflict generated by a difference between the first time and the second time is resolved based on a predetermined rule.

2. The method of claim 1, wherein the predetermined rule requires using a flexible action time instead of one of the first time and the second time.

3. The method of claim 1, wherein the predetermined rule extends a shorter among the first time and the second time to match a longer among the first time and the second time.

4. The method of claim 1, wherein the predetermined rule includes using a default beam to initiate the switching until the first time if the first time is later than the second time.

5. The method of claim 1, wherein the predetermined rule is the first time coincides with a third time when the switching is completed.

6. The method of claim 1, further comprising:
transmitting, to the network entity, a UE capability report indicating a capability of the UE for resolving the timing conflict using the predetermined rule.

7. The method of claim 6, wherein the UE capability report specifies the predetermined rule.

8. The method of claim 1, further comprising:
receiving a configuration to perform at least one of
enabling to resolve the timing conflict using the predetermined rule, or
configuring the one or more candidate cells.

9. The method of claim 1, a value of the first time depends on whether the at least one beam is used for communicating with the source cell or the target cell.

10. The method of claim 9, the receiving of the beam indication includes decoding a Medium Access Control-Control Element (MAC-CE).

11. The method of claim 1, the first time is determined by applying a first time delay to a time of transmitting a last symbol of a message that acknowledges the receiving of the beam indication.

12. The method of claim 1, further comprising:
receiving, from the network entity, an indication specifying a validation time window; and
determining that the receiving of the CSC indicating the target cell occurs within the validation time window after the receiving of the beam indication.

13. (canceled)

14. The method of claim 12, further comprising:
discarding a first signal if the UE does not detecting a second signal during the validation window, wherein the first signal includes the beam indication or the CSC and the second signal includes the beam indication or the CSC which is not included in the first signal.

15. The method of claim 1, further comprising:
receiving, from the network entity, an indication specifying a time interval;
initiating a timer measuring the time interval after a transmission that acknowledges the receiving of the beam indication; and
terminating the switching from the source cell to the target cell if the switching from the source cell to the target cell is not complete when the time interval expires.

16. A method of wireless communication at a network entity, comprising:
directing a user equipment, UE, via a source cell, to use a predetermined rule for resolving a timing conflict associated with a beam indication and a cell switch command (CSC) that define a procedure for the UE to switch from communicating via the source cell to communicating via a target cell specified in the CSC and to use a beam specified in the beam indication for communicating via the target cell, the beam indication indicating the beam using transmission configuration indicator (TCI) state to receive a downlink (DL) transmission or to transmit an uplink (UL) transmission; and
receiving from the UE a signal indicating the UE initiating the procedure.

17. The method of claim 16, further comprising:
receiving, from the UE, a UE capability report indicating UE's ability to resolve timing conflicts based on the predetermined rule.

18. An apparatus for wireless communication at a user equipment (UE), comprising:
a transceiver;
a memory; and
a processor coupled to the memory and the transceiver, the processor configured to:
receive, from a network entity connected to the UE via a source cell, a beam indication for indicating at least one beam for the UE to communicate via a target cell among one or more candidate cells with the network entity;
receive, from the network entity, a cell switch command (CSC) indicating the target cell, wherein the beam indication is effective at a first time and the CSC is effective at a second time, the beam indication indicating the at least one beam using transmission configuration indicator (TCI) state to receive a downlink (DL) transmission or to transmit an uplink (UL) transmission; and
switch from the source cell to the target cell and using the at least one beam, wherein a timing conflict generated by a difference between the first time and the second time is resolved based on a predetermined rule.

19. The apparatus of claim 18, wherein the predetermined rule is the first time coincides with a third time when the switching is completed.

20. The apparatus of claim 18, wherein the processor is further configured to:
transmit, to the network entity, a UE capability report indicating a capability of the UE for resolving the timing conflict using the predetermined rule.

21. The apparatus of claim 20, wherein the UE capability report specifies the predetermined rule.
